(19) United States
(12) Patent Application Publication
(10) Pub. No.: US 2014/0105718 A1
(43) Pub. Date: Apr. 17, 2014

(54) DEVICE AND METHOD FOR LOWERING LIMBS FROM A TREE

(71) Applicant: Leonard Earl Person, Dudley, NC (US)

(72) Inventor: Leonard Earl Person, Dudley, NC (US)

(21) Appl. No.: 13/649,109

(22) Filed: Oct. 11, 2012

(51) Int. Cl. A01G 23/099; B65H 59/14

(52) U.S. Cl. 414/800; 188/65.2

(57) ABSTRACT

A limb lowering system can hold the weight of large tree limbs while lowering them from a tree. The system does away with tree-mounted devices and wrapping ropes around trees which often leads to knotted ropes as well as the snatching and jerking of ropes. The system includes a rope guide that attaches to a receiver hitch of a vehicle. The rope guide has prongs on it to keep the rope from overlapping, allowing the rope to glide smoothly and keeping the rope from knotting. The system installs quickly and easily by a single pin.

### BACKGROUND OF THE INVENTION

The present invention relates to tree cutting accessories and, more particularly, to a device and method for wrapping a rope around to lower large limbs from a tree.

Conventional devices to help lower limbs from a tree as they are cut are usually strapped to a tree and require the users to adjust them while lowering a limb. These conventional devices are not stationary, can knot up ropes, do not provide smooth operation and takes a relatively long time to set up and use. These conventional devices are not stationary, so that move and bounce around, which could result in injury to the person using it.

As can be seen, there is a need for an improved method and device for quickly, easily and safely lowering a cut limb from a tree.

### SUMMARY OF THE INVENTION

In one aspect of the present invention, a tree limb lowering device comprises a tubing fitting into a receiver hitch of a vehicle; a hitch pin hole formed through the tubing; a cylinder attached to the tubing; and a plurality of rods passing through the cylinder and extending out of the cylinder at opposite sides thereof, wherein the plurality of rods pass through rod holes formed through the cylinder.

In another aspect of the present invention, a tree limb lowering device comprises a tubing fitting into a receiver hitch of a vehicle; a hitch pin hole formed through the tubing; a cylinder attached to the tubing; a plurality of rods passing through the cylinder and extending out of the cylinder at opposite sides thereof, wherein the plurality of rods pass through rod holes formed in a line along each side of the cylinder; and a plate disposed on one end of the cylinder, the plate being larger than a diameter of the cylinder.

In a further aspect of the present invention, a method for lowering a tree limb comprises attaching a first end of a rope around a tree limb to be cut; and wrapping a second end of the rope around a cylinder having a plurality of pins disposed therethrough and extending out of the cylinder at opposite sides thereof, the cylinder attached to a tubing, the tubing fitting into a receiver hitch of a vehicle; and allowing the rope to turn around the cylinder as the limb is lowered.

These and other features, aspects and advantages of the present invention will become better understood with reference to the following drawings, description and claims.

### BRIEF DESCRIPTION OF THE DRAWINGS

FIG. 1 is a perspective view of a limb lowering device, in use, according to an exemplary embodiment of the present invention;

FIG. 2 is a perspective view of the limb lowering device of FIG. 1 detached from a receiver hitch of a vehicle;

FIG. 3 is a perspective view of the limb lowering device of FIG. 1;

FIG. 4 is an exploded perspective view of the limb lowering device of FIG. 1;

FIG. 5 is a perspective view of the limb lowering device of FIG. 1 showing an exemplary rope wrap therealong; and

FIG. 6 is a cross-sectional view taken along line 6-6 of FIG. 3.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a limb lowering system that can hold the weight of large tree limbs while lowering them from a tree. The system does away with tree-mounted devices and wrapping ropes around trees which often leads to knotted ropes as well as the snatching and jerking of ropes. The system of the present invention includes a rope guide that attaches to a receiver hitch of a vehicle. The rope guide has prongs on it to keep the rope from overlapping, allowing the rope to glide smoothly and keeping the rope from knotting. The system installs quickly and easily by a single pin.

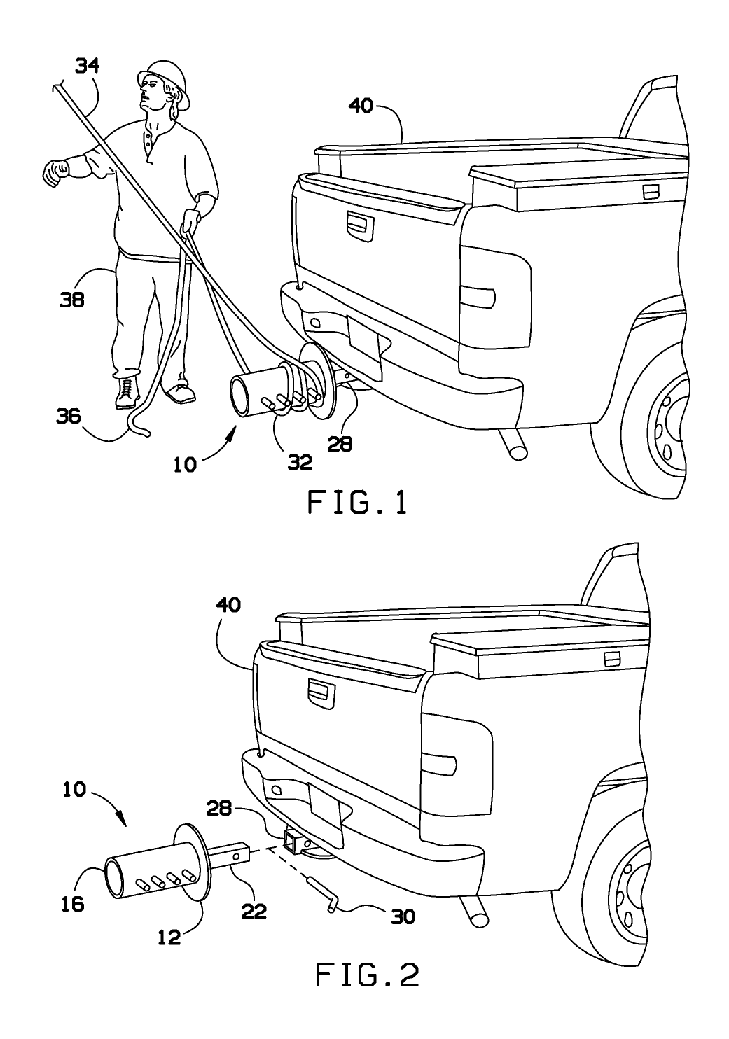

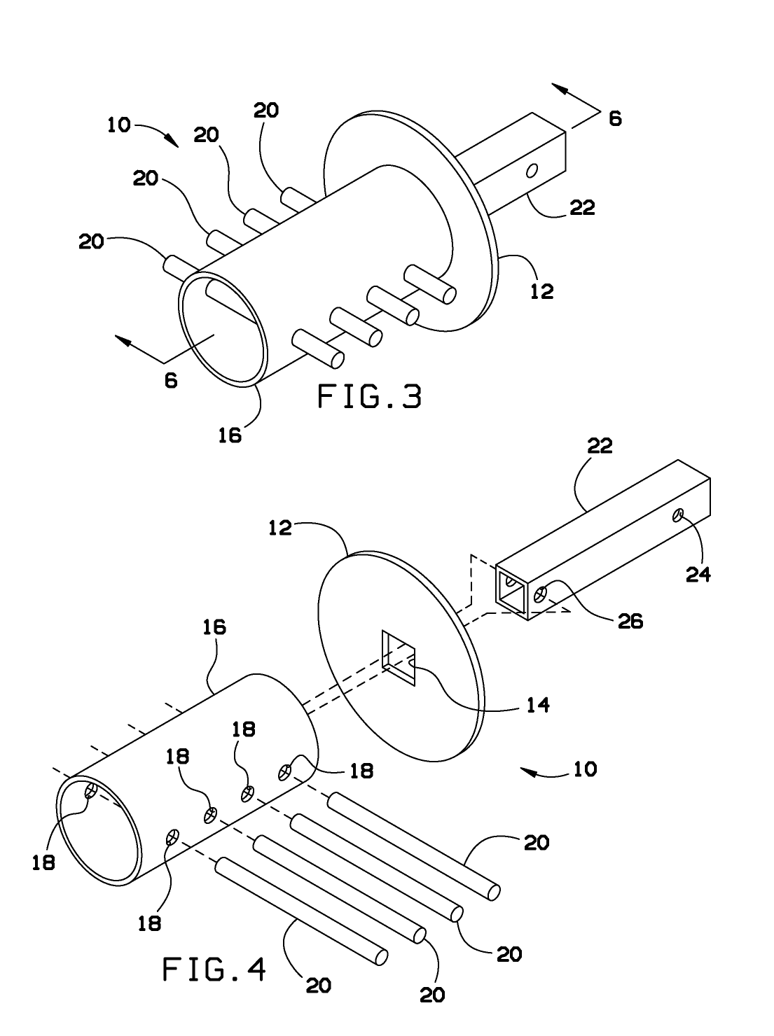

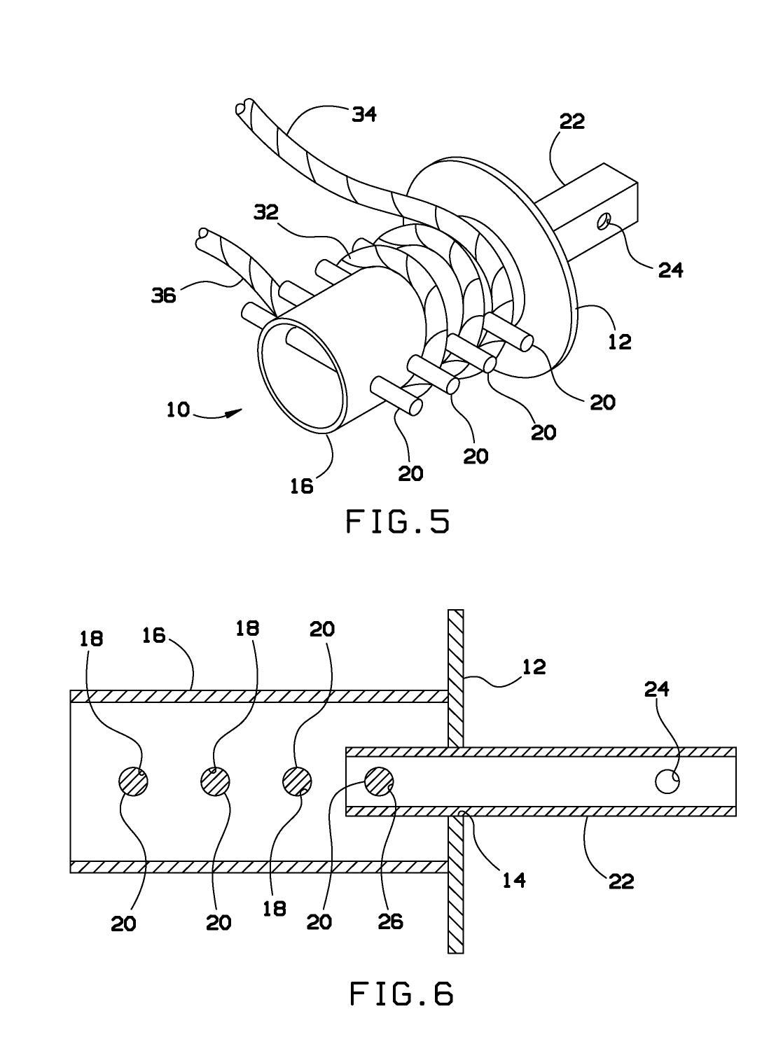

Referring now to FIGS. 1 through 6, a tree limb lowering device assembly 10 includes a square tubing 22 that includes a hitch pin hole formed through the tubing 22 at a first end thereof. The tubing 22 can fit into a receiver hitch 28 of a vehicle 40. A hitch pin 30 can secure the tubing 22 into the receiver hitch 28. This provides a stationary support for the tree limb lowering device assembly 10.

The tubing 22 can include a rod hole 26 in a second, opposite end thereof. The tubing 22 can fit into a square cutout 14 in a round metal plate 12. The plate 12 can be attached on one end of a metal cylinder 16. The metal cylinder 16 can include a plurality of cylinder rod holes 18 formed therethrough. Metal rods 20 can fit through the cylinder rod holes 18 and extend out from each end of the cylinder 16. Typically, the rods 20 can extend from about 1 to about 4 inches from each side of the cylinder 16. One of the rods 20, adjacent to the metal plate 12, can extend through the rod holes 26 cut through the tubing 22.

The tubing 22 can be attached to the rod 20 by, for example, welding. The plate 12 can be attached to the cylinder 16 and the tubing 22 by, for example, welding. Similarly, the rods 20, passing through the cylinder 16, can be attached by various methods, such as by welding.

To use the tree limb lowering device assembly 10, a user 38 can attach the assembly 10 to the vehicle 40 to secure the assembly 10. One end 34 of a rope 32 can be attached to a tree limb to be cut and lowered to the ground. Another end 36 of the rope 32 can wrap around the cylinder 16, with the rods 20 preventing overlapping of the rope 32. The user 38 can simply grasp the end 36 of the rope and, after the limb is cut, the user 38 can easily and smoothly allow the rope to lower the limb to the ground. Typically, a user can lower the rope with one hand, as much of the weight of the limb is taken by the assembly 10 attached to the vehicle 40.

While the above describes using the assembly 10 to lower limbs, the assembly 10 can be used for other uses. For example, the assembly 10 could be used to pull by using the vehicle.

It should be understood, of course, that the foregoing relates to exemplary embodiments of the invention and that modifications may be made without departing from the spirit and scope of the invention as set forth in the following claims.

1. A tree limb lowering device comprising:
a tubing having a first tubing end fitting into a receiver hitch of a vehicle;
a hitch pin hole formed through the tubing, the hitch pin hole aligning with a receiver hitch pin hole in the receiver hitch of the vehicle;
a cylinder, the cylinder having a cylinder first end attached to a tubing second end of the tubing;
a plate disposed on the cylinder first end, the plate being larger than a diameter of the cylinder; and
a plurality of rods passing through the cylinder, each of the plurality of rods extending out of the cylinder at opposite sides thereof, wherein each of the plurality of rods pass through rod holes formed through the cylinder.

2. The tree limb lowering device of claim 1, wherein the rod holes are aligned in a line along each side of the cylinder.

3. (canceled)

4. The tree limb lowering device of claim 1, wherein at least one of the plurality of rods extends through a rod hole formed in the tubing.

5. The tree limb lowering device of claim 1, further comprising a hitch pin fitting through the hitch pin hole in the tubing and the receiver hitch pin hole in the receiver hitch of the vehicle.

6. A tree limb lowering device comprising:
a tubing having a first tubing end fitting into a receiver hitch of a vehicle;
a hitch pin hole formed through the tubing, the hitch pin hole aligning with a receiver hitch pin hole in the receiver hitch of the vehicle;
a cylinder, the cylinder having a cylinder first end attached to a tubing second end of the tubing;
a plurality of rods passing through the cylinder and extending out of the cylinder at opposite sides thereof, wherein the plurality of rods pass through rod holes formed in a line along each side of the cylinder;
at least one rod hole formed in the tubing second end, wherein the at least one rod hole receives at least one of the plurality of rods to secure the cylinder to the tubing, the cylinder fitting about the tubing second end; and
a plate disposed on the cylinder first end, the plate being larger than a diameter of the cylinder.

7. The tree limb lowering device of claim 6, wherein the plurality of rods includes at least four rods.

8. (canceled)

9. The tree limb lowering device of claim 6, further comprising a hitch pin fitting through the hitch pin hole in the tubing and a hole in the receiver hitch of the vehicle.

10. A method for lowering a tree limb comprising:
attaching a first end of a rope around a tree limb to be cut; and
wrapping a second end of the rope around a cylinder having a plurality of pins disposed therethrough, the plurality of pins preventing overlap of the rope, and extending out of the cylinder at opposite sides thereof, the cylinder attached to a tubing, the tubing fitting into a receiver hitch of a vehicle; and
allowing the rope to turn around the cylinder as the limb is lowered.
